(19) United States
(12) Patent Application Publication
(10) Pub. No.: US 2026/0189407 A1
(43) Pub. Date: Jul. 2, 2026

(54) COMMUNICATION PROTOCOL

(71) Applicant: nCHAIN LICENSING AG, Zug (CH)

(72) Inventors: Daniel JOSEPH, London (GB); Craig Steven WRIGHT, London (GB)

(21) Appl. No.: 19/131,903

(22) PCT Filed: Nov. 2, 2023
(86) PCT No.: PCT/EP2023/080610

§ 371 Date: May 21, 2025

(30) Foreign Application Priority Data
Nov. 23, 2022 (GB) 2217489.0

(51) Int. Cl. H04L 9/32; H04L 9/08

(52) U.S. Cl. CPC H04L 9/3263; H04L 9/0825

(57) ABSTRACT

A computer-implemented method for secure communication between a set of nodes, wherein a sequence of security levels is defined, wherein a first security level in the sequence is defined as being a most secure level and a final security level in the sequence is defined as being a least secure level, and wherein a respective security of respective security levels in the sequence is defined as decreasing from the first security level to the final security level, wherein each respective node has a respective security certificate associated with a respective security level, wherein each node is configured to communicate with other nodes according to a communication protocol, wherein the method is performed by a first node having a first certificate communicating with a second node having a second certificate according to the communication protocol.

### CROSS REFERENCE TO RELATED APPLICATIONS

This application is the U.S. National Stage of International Application No. PCT/EP2023/080610 filed on Nov. 2, 2023, which claims the benefit of United Kingdom Patent Application No. GB2217489.0, filed on Nov. 23, 2022, the contents of which are all incorporated herein by reference in their entireties.

### TECHNICAL FIELD

The present disclosure relates to a method for communicating between nodes in a secure manner and to a method of enabling nodes to communicate in a secure manner.

### BACKGROUND

The nodes in a computer network, including the Internet can be fairly heterogenous. These network-connected computers can vary from IoT devices and smart phones to supercomputers and data centres for cloud computing. Each piece of hardware is characterised by its corresponding level of, inter alia, computing power, functionality, and data storage. At the same time the software that run on the hardware, both applications and operating systems, also serve to define the device.

A device on the network may also be characterised by the security that the device is able to provide and/or require. As an example, the data centre of a large corporation would require greater security measures than that of a random IoT device in a home network. Given the varying security assurance levels certain nodes can provide, it is prudent that a certain node restricts the nodes to which it communicates, based on its confidence in the security level that these other nodes can provide.

### SUMMARY

According to one aspect disclosed herein, there is provided a computer-implemented method for secure communication between a set of nodes, wherein a sequence of security levels is defined, wherein a first security level in the sequence is defined as being a most secure level and a final security level in the sequence is defined as being a least secure level, and wherein a respective security of respective security levels in the sequence is defined as decreasing from the first security level to the final security level, wherein each respective node has a respective security certificate associated with a respective security level, wherein each node is configured to communicate with other nodes according to a communication protocol, and wherein the communication protocol defines at least the following rules:
i) a respective node having a respective certificate associated with a respective security level can send messages to a respective node having a respective certificate associated with any less secure security level in the sequence,
ii) a respective node having a respective certificate associated with a respective security level can send messages to a respective node having a respective certificate associated with a next more secure security level adjacent to the respective security level in the sequence;
iii) a respective node having a respective certificate associated with a respective security level can receive messages from a respective node having a respective certificate associated with a less secure security level adjacent to the respective security level in the sequence; and
iv) a respective node having a respective certificate associated with a respective security level can receive messages from a respective node having a respective certificate associated with any more secure security level in the sequence, and
wherein the method is performed by a first node having a first certificate communicating with a second node having a second certificate according to the communication protocol.

According to another aspect disclosed herein, there is disclosed a computer-implemented method for secure communication between a set of nodes, wherein a sequence of security levels is defined, wherein a first security level in the sequence is defined as being a most secure level and a final security level in the sequence is defined as being a least secure level, and wherein a respective security of respective security levels in the sequence is defined as decreasing from the first security level to the final security level, wherein each respective node has a respective security certificate associated with a respective security level, wherein each node is configured to communicate with other nodes according to a communication protocol, and wherein the communication protocol defines at least the following rules:
i) a respective node having a respective certificate associated with a respective security level can send messages to a respective node having a respective certificate associated with any less secure security level in the sequence,
ii) a respective node having a respective certificate associated with a respective security level can send messages to a respective node having a respective certificate associated with any one of one or more, but not all, of the next more secure security levels in the sequence;
iii) a respective node having a respective certificate associated with a respective security level can receive messages from a respective node having a respective certificate associated with any one or more, but not all, of the less secure security levels in the sequence; and
iv) a respective node having a respective certificate associated with a respective security level can receive messages from a respective node having a respective certificate associated with any more secure security level in the sequence, and
wherein the method is performed by a first node having a first certificate communicating with a second node having a second certificate according to the communication protocol.

Embodiments of the present disclosure provide a protocol for communication between the nodes in a network with n security levels, where a node can only engage in communications with other nodes based on the relative security levels of the nodes. Each node in the network is assigned a security certificate which attests to the node's security level. In some examples, the certification of a node's security is represented on a blockchain. The protocol enables nodes to communicate securely within a network.

According to another aspect disclosed herein, there is provided a computer implemented method of issuing security certificates for secure communication between a set of nodes, wherein a sequence of security levels is defined, wherein a first security level in the sequence is defined as being a most secure level and a final security level in the sequence is defined as being a least secure level, and wherein a respective security of respective security levels in the sequence is defined as decreasing from the first security level to the final security level, wherein each respective node has a respective security certificate associated with a respective security level, wherein each certificate authority of a set of certificate authorities is associated with a respective security level, wherein each security certificate associated with a respective security level is signed by a respective certificate authority associated with the respective security level, wherein each certificate authority is configured to issue security certificates according to a certificate issuance protocol, and wherein the certificate issuance protocol defines at least the following rules:
i) a certificate authority associated with a respective security level can issue security certificates associated with the same respective security level;
ii) a certificate authority associated with a respective security level can issue a security certificate to a node having a security certificate with a less secure security level adjacent to the respective security level in the sequence; and
iii) a certificate authority associated with a respective security level can re-issue a security certificate to a node having an expired or revoked certificate associated with the same respective security level, and
wherein the method is performed by a first certificate authority and comprises issuing a security certificate to a requesting node according to the certificate issuance protocol.

According to another aspect disclosed herein, there is disclosed a computer implemented method of issuing security certificates for secure communication between a set of nodes, wherein a sequence of security levels is defined, wherein a first security level in the sequence is defined as being a most secure level and a final security level in the sequence is defined as being a least secure level, and wherein a respective security of respective security levels in the sequence is defined as decreasing from the first security level to the final security level, wherein each respective node has a respective security certificate associated with a respective security level, wherein each certificate authority of a set of certificate authorities is associated with a respective security level, wherein each security certificate associated with a respective security level is signed by a respective certificate authority associated with the respective security level, wherein each certificate authority is configured to issue security certificates according to a certificate issuance protocol, and wherein the certificate issuance protocol defines at least the following rules:
i) a certificate authority associated with a respective security level can issue security certificates associated with the same respective security level;
ii) a certificate authority associated with a respective security level can issue a security certificate to a node having a security certificate with any one of one or more, but not all, of the less secure security levels in the sequence; and
iii) a certificate authority associated with a respective security level can re-issue a security certificate to a node having an expired or revoked certificate associated with the same respective security level, and
wherein the method is performed by a first certificate authority and comprises issuing a security certificate to a requesting node according to the certificate issuance protocol.

Embodiments also provide a protocol for the issuance of security certificates to nodes, where a node can only obtain a security certificate for a given security level from a certificate authority that is authorised to provide security certificates for that level. In some examples, the security certificates are published on the blockchain.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of an example system with multiple security levels (zones),

FIG. 4 schematically illustrates example lines of communication between nodes in different security zones,

FIG. 5 schematically illustrates example lines of communication between nodes and Certificate Authorities,

FIG. 6 schematically illustrates example relationships between security and CA certificates, and

FIG. 7 schematically illustrates an example process for certification of nodes.

### DETAILED DESCRIPTION OF EMBODIMENTS

### 1. Communication and Certificate Issuance Protocols

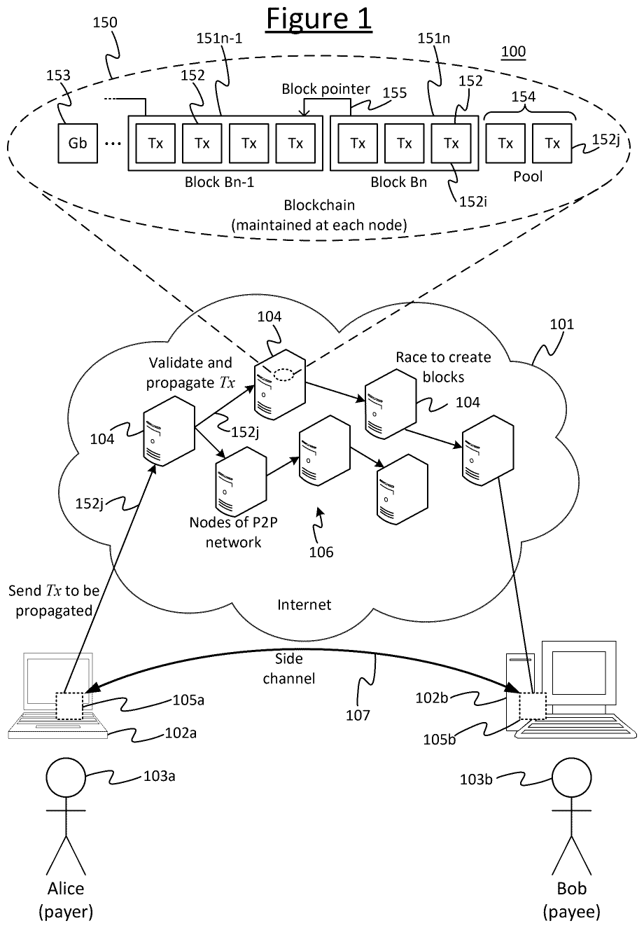

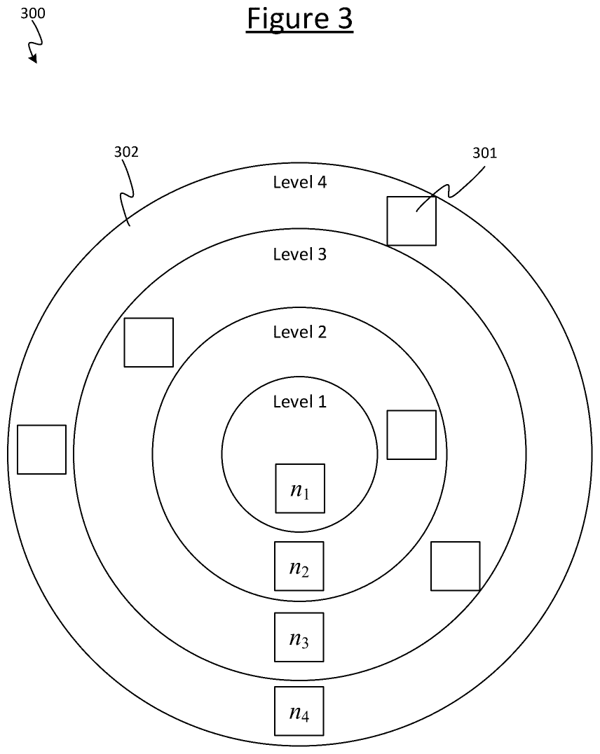

FIG. 3 illustrates an example system 300 for implementing embodiments of the present disclosure. The system 300 comprises a plurality of nodes 301. Each node 301 is a computing device. Some or all nodes 301 may take the same form of computing device, or some or all nodes 301 may take different forms of computing devices. Together the nodes 301 form a network of devices. Note that nodes 301 are not to be confused with blockchain nodes 104 described below with reference to FIG. 1, though it is not to excluded that a node 301 may be a blockchain node 104.

Each node 301 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The system 300 comprises a plurality of security layers, or security levels, or security zones 302. Note that these layers 302 may be physical, e.g. different zones of a building, or non-physical, i.e. the system 300 need not have any physical barriers or separations between layers 302. The security layers 302 are defined in a sequence, starting with a first (or initial) layer and ending with a last (or final) layer. The first layer is the most secure layer and the last layer is the least secure layer. The layers get less secure with each layer from the first layer to the last layer. For simplicity, the most secure layer is labelled “Level 1” in FIG. 3 and the least secure layer is labelled “Level 4” (there are only four layers in this example). However it should be noted that Level 4 could be the most secure layer and Level 1 could be the least secure layer. It will be appreciated that the system 300 may contain any number of nodes 301 and have any number of layers 302.

Each node 301 is associated with a ‘security certificate’, i.e. a digital certificate signed by a certificate authority 303 (not shown in FIG. 3). A certificate authority 303 is an entity assigned the responsibility and authority of issuing security certificates for use by nodes 301 of the system 300. A security certificate may comprise an identifier of the node 301 to which the security certificate is issued. The identifier may comprise a network identifier of the node 301, such as an IP (e.g. IPv6) address. The identifier may comprise a public key of the node 301, i.e. a public key of which the node 301 has control of the corresponding private key. A security certificate may comprise, or be signed by, a signature of the certificate authority 303 that issued the certificate. Security certificates may be stored on the blockchain 150, as discussed below.

A security certificate is associated with a given security layer 302. For instance, a security certificate may be associated with the most secure layer (e.g. Level 1), or the least secure layer (e.g. Level 4), or an intermediate layer (e.g. Level 2). A security certificate is only associated with a single security layer 302.

Nodes 301 are configured to communicate with each other based on a communication protocol, i.e. according to rules defined by the communication protocol. More specifically, nodes 301 can only communicate if the communication adheres to all of the rules. That is, no other communications are permitted.

A first rule of the communication protocol is that a node 301 having a security certificate associated with a given security layer 302 can send messages to a node 301 having a security certificate associated with any less secure security layer 302.

A second rule of the communication protocol is that a node 301 having a security certificate associated with a given security layer 302 can send messages to a node 301 having a security certificate associated with the next more secure security layer 302, but not any security layers above (i.e. more secure) than the next more secure security layer 302. For example, a node in Level 1 can send messages to nodes 301 in Level 2, Level 3 and Level 4 (meeting the first rule). A node 301 in Level 2 can send messages to nodes 301 in Level 3 and Level 4 (meeting the first rule) and to nodes in Level 1 (meeting the second rule). A node 301 in Level 3 can send messages to nodes in Level 4 (meeting the first rule) and to nodes in Level 2 (meeting the second rule), but not nodes in Level 1 (due to the second rule). Nodes 301 can also send messages to other nodes 301 having the same security certificate (i.e. a security certificate associated with the same security layer 302).

A third rule of the communication protocol is that a node 301 having a security certificate associated with a given security layer 302 can receive messages from a node 301 having a security certificate associated with any more secure security layer 302.

A fourth rule of the communication protocol is that a node 301 having a security certificate associated with a given security layer 302 can receive messages from a node 301 having a security certificate associated with the next less secure security layer 302, but not any security layers lower (i.e. less secure) than the next less secure security layer 302.

For example, a node in Level 1 can receive messages from nodes 301 in Level 2 (meeting the fourth rule), but not from nodes in Level 3 or Level 4 (due to the fourth rule). A node 301 in Level 2 can receive messages from nodes 301 in Level 1 (meeting the third rule) and from Level 3 (meeting the fourth rule), but not from nodes in the Level 4 (due to the fourth rule). A node 301 in Level 3 can receive messages from nodes 301 in Level 1 and Level 2 (meeting the third rule) and from nodes in Level 4 (meeting the fourth rule). Nodes 301 can also receive messages from other nodes 301 having the same security certificate (i.e. a security certificate associated with the same security layer 302).

In some examples, the second and fourth rules of the communication protocol may be less strict as compared to the examples described above. For instance, the second rule may be relaxed to allow a node to send messages to nodes in more than just the adjacent more secure security level. Similarly, the second rule may be relaxed to allow a node to receive and accept messages from nodes in more than just the adjacent less secure security level. In general, a node may send messages to nodes in any but not all of the more secure security levels, and to receive messages from nodes in any but not all of the less secure security levels. For instance, a node may send messages to nodes in the next n more secure security levels, where n is less than the number of remaining more secure security levels in the sequence, and a node may receive messages from the nodes in the next m less secure security levels, where m is less than the number of remaining less secure security levels in the sequence. In some examples, n and m is the same number. n and m may define a threshold number of security levels. The threshold may be defined by a user of the system of nodes. The threshold may be based on one or more properties of the system, such as one or more properties of the nodes, e.g. the type of communication (such as wired or wireless) between the nodes and/or the type of data (e.g. based on a measure of sensitivity) communicated between the nodes and/or one or more properties of the sequence of levels (e.g. a total number of levels in the sequence). As a particular example, the threshold may be set as being equal to a function (e.g. round, ceiling, or truncate) of at least the number of levels, e.g. round(number of levels/4).

The communication protocol may define that messages are to be sent in an encrypted form. Thus any mention of sending a message may be taken to mean that the message is an encrypted message, unless the context requires otherwise.

The communication protocol may define that messages sent between (i.e. to and from) nodes 301 within and between security layers 302 may be encrypted with a symmetric encryption key or an asymmetric encryption key. In some examples, symmetric encryption is used to encrypt messages sent between nodes 301 within security layers 302. In some examples, and asymmetric encryption is used to encrypt messages sent between nodes 301 between security layers 302.

As a specific example, the communication protocol may define that messages sent between (i.e. to and from) nodes 301 of adjacent security layers 302 are encrypted with an encryption key based on a public key of the node 301 receiving the message (the receiving node) and a private key of the node 301 sending the message (the sending node). The encryption key may also be generated using the private key of the receiving node and the public key of the sending node. The encryption key may be a symmetric encryption key. The encryption key may be generated using a Diffie-Helman key exchange (described below). The public and private keys may be elliptic curve keys.

The communication protocol may define that messages send between (i.e. to and from) nodes 301 of non-adjacent security layers 302 are encrypted with an encryption key based on a public key of the receiving node only. The public key may be an RSA key.

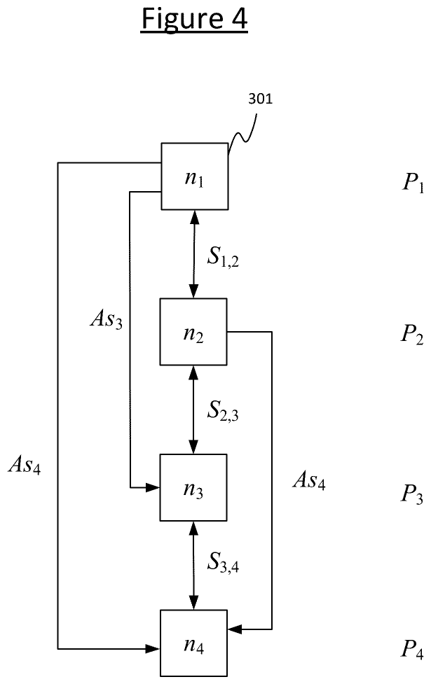

FIG. 4 schematically illustrates messages being sent between adjacent nodes 301 (i.e. nodes 301 associated with adjacent security layers 302) and between non-adjacent nodes 301 (i.e. nodes 301 associated with non-adjacent security layers 302). As shown, messages sent between node n₁ (Level 1) and node n₂ (Level 2) are encrypted with symmetric key S_{1,2} generated using a key of node n₁ and a key of node n₂. Messages sent between node n₁ (Level 1) and node n₃ (Level 3) are encrypted with an asymmetric key As₃ generated using a public key of node n₃.

Other encryption schemes may be used for either type of messages.

The communication protocol may define a process that must be performed in order for messages to be communicated between nodes of adjacent security layers 302 for the first time, e.g. a handshake procedure. The sending node 301 first sends a request to the receiving node 301. The request includes the sending node's certificate or a reference to where the certificate is located. For example, the reference may include a transaction identifier of a transaction on the blockchain 150, the transaction including the certificate. The receiving node 301 verifies the security certificate. This may include verifying that the certificate includes, or is signed by, a signature of a certificate authority authorised to issue security certificates. This may also include verifying that the certificate of the sending node 301 is associated with an appropriate security level, i.e. the sending node is associated with a security level from which communications are allowed to be sent to the receiving node 301 based on the rules of the communication protocol.

If the verification of the security certificate passes, the receiving node 301 sends a verification message to the sending node (this message may or may not be encrypted). The sending node 301 signs the verification message using its private key and sends the resulting verification signature to the receiving node 301. The receiving node 301 verifies the verification signature. That is, the receiving node 301 verifies that the signature is valid for the sending node's public key. If the verification of the signature passes, the receiving node 301 will accept messages from the sending node 301. This may comprise performing a Diffie-Helman key exchange, or similar, with the sending node 301 to establish an encryption key.

The communication protocol may define a process that must be performed in order for messages to be communicated between nodes of non-adjacent security layers 302 when the receiving node 301 is located in a more secure layer than the sending node 301. In this case, the sending node 301 must send the message (which may be encrypted) to an intermediate node in an adjacent, more secure layer and request that the message is forwarded to the receiving node 301. If the intermediate node 301 is in an adjacent layer to the receiving node 301, the intermediate node 301 sends the message to the receiving node. If the intermediate node 301 is not in an adjacent layer to the receiving node 301, the intermediate node 301 forwards the message to another intermediate layer in an adjacent, more secure layer and requests that the message is forwarded to the receiving node 301. This process may be repeated one or more times until the message is eventually received by the receiving node 301.

In some examples, a further rule may be defined by the communication protocol. In these examples, each security layer is associated a most secure security layer to which nodes in the given security layer can communicate. That is, when this rule is implemented, an upper limit is placed on the security layers to which nodes can communicate. A node in a security layer can communicate to nodes in more secure layer, up to the defined most secure security layer, but not to nodes in more secure layers. Note here that “most secure security layer” does not necessarily mean the most secure security layer in the sequence of security layer. Furthermore, the rule defines that for adjacent layers, nodes in the less secure layer cannot communicate with nodes that are more secure than nodes to which the nodes in the more secure layer can communicate. Put another way, let n be a security layer, and L(n) be the most secure layer that a node we can message directly from layer n. The rule defines that L(n)<=L(n+1).

In some embodiments, the certificate authorities (CAs) 303 are also arranged in security layers, i.e. each CA 303 is associated with a respective security layer. In these embodiments, each CA 303 is configured to issues security certificates according to a certificate issuance protocol, i.e. according to rules defined by the certificate issuance protocol. More specifically, a CA 301 can only issue certificates if the issuance adheres to all of the rules.

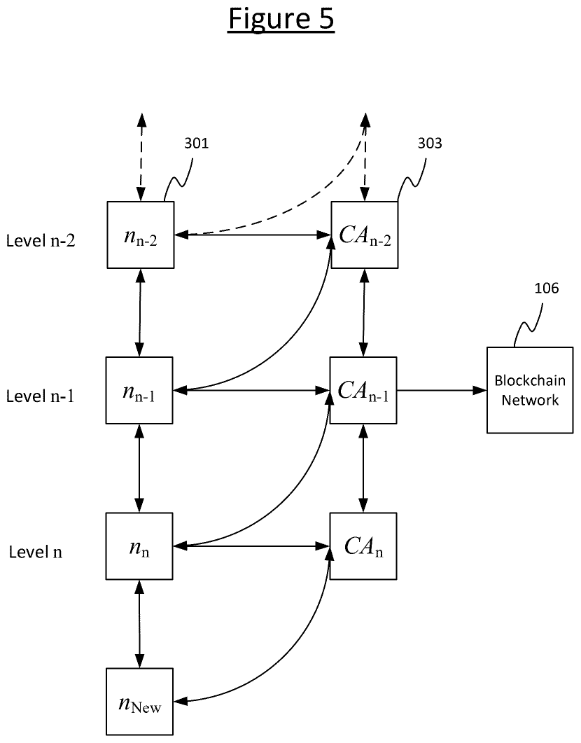

A first rule of the certificate issuance protocol is that a CA 303 can issue certificates associated with the same security level 302 of which the CA 303 is associated. That is, a CA 303 can issue certificates to a node 301 for the security level 302 occupied by the CA 303. For example, referring to FIG. 5, CAₙ in level n can issue a certificate to node nₙ.

A second rule of the certificate issuance protocol is that a CA 303 can issue certificates associated with an adjacent, less secure security level, but not any certificate associated with any non-adjacent, less secure security levels. For example, CAₙ₋₂ can issues a certificate to node nₙ₋₁ in level n−1 but not to node nₙ in level n.

A third rule of the certificate issuance protocol is that a CA 303 can re-issue certificates to nodes 301 that previously had a security certificate associated with the same security level as the CA 303. For example, a node 303 may re-apply for a certificate after the previous certificate was revoked or expired.

A fourth rule of the certificate issuance protocol is that a CA 303 cannot issue certificates associated with a more secure security level.

In some examples, the second rule of the certificate issuance protocol may be less strict as compared to the examples described above. For instance, the second rule may be relaxed to allow the issuance of certificates to nodes in more than just the adjacent less secure security level. In general, a CA may issue certificates to nodes in any but not all of the less secure security levels. For instance, a CA may issue certificates to nodes in the next x less secure security levels, where x is less than the number of remaining less secure security levels in the sequence. x and m may define a threshold number of security levels. The threshold may be defined by a user of the system of nodes. The threshold may be based on one or more properties of the system, such as one or more properties of the nodes, e.g. the type of communication (such as wired or wireless) between the nodes and/or the type of data (e.g. based on a measure of sensitivity) communicated between the nodes and/or one or more properties of the sequence of levels (e.g. a total number of levels in the sequence). As a particular example, the threshold may be set as being equal to a function (e.g. round, ceiling, or truncate) of at least the number of levels, e.g. round(number of levels/4).

A node 301 and CA 303 may interact in the following way to obtain a certificate. The node 301 requesting the certificate (the requesting node) sends a request to a CA 303 associated with a particular security level 302 for a certificate associated with that level 302. The CA 303 performs one or more checks to determine that the requesting node 301 is eligible for such a certificate. This may comprise determining if the requesting node 301 has a valid certificate for the adjacent, less secure level 302. If the verification passes, the CA 303 generates a security certificate associated with the requesting node 301 and the security level associated with the CA 303. The security certificate is sent to the requesting node 301. In some examples, the CA 303 submits a transaction to the blockchain 150 which includes the security certificate and/or a hash of the security certificate.

The communication protocol may define how nodes 301 can communicate with CAs 303 and/or how CAs 303 can communicate with one another.

Starting with the interaction between a node 301 and a CA 303, the communication protocol may define that a node 301 having a security certificate associated with a given security layer 302 can send messages to and receive message from a CA 303 having a security certificate associated with the same layer 302 or an adjacent layer 302. A node 301 having a security certificate associated with a given security layer 302 can request a security certificate from a CA 303 associated with an adjacent, more secure security layer 302, but not a non-adjacent, more secure security layer 302.

With regards to the interaction between CAs, a CA 303 associated with a given security layer 302 can communicate with CAs 303 associated with the same security layer 302 and CAs 303 associated with adjacent security layers 302.

Further optional examples are described below.

### 2. Cryptographic Techniques

### 2.1 X.509 Certificate

X.509 is a standard format for public key certificates, digital documents that securely associate cryptographic key pairs with identities such as websites, individuals, or organizations. Each X.509 certificate includes at least a public key, digital signature, and information about both the identity associated with the certificate and its issuing certificate authority (CA).

The information fields included details such as name and address or organization, details of the signature algorithm used, and expiry date. X.509 certificates can be revoked before the expiry date. may be revoked.

The transparency and immutable characteristics of blockchains are often noted as useful in the issuance and storage of digital certificates.

### 2.2 Diffie-Hellman

Secure communication between nodes can be accomplished through encryption. This can be done using either symmetric and asymmetric encryption solutions. For symmetric encryption, a Diffie-Hellman exchange may be utilised to securely establish a shared key between a pair of nodes. For Elliptic Curve cryptography a Diffie-Hellman exchange can be accomplished through the following steps
1. Each party creates their public-private key pair using secp256k1. Bob (v_{B},P_{B}), Alice (v_{A},P_{A}) where P_{B}=v_{B}G and P_{A}=v_{A}G.
2. Each parties shares their public key with the other. Bob gives Alice the key PB, Alice gives Bob the key P_{A}. This can be done over a public channel.
3. Each party multiplies the other's public key by their (original party's) private key. Bob calculates v_{B}P_{A}. Alice calculates v_{A}P_{B}.
4. Both parties are now in possession of the shared key that can be used for symmetric encryption.

$${S}_{AB} = {v}_{B} {P}_{A} = {v}_{A} {P}_{B} = {v}_{B} {v}_{A} G = {v}_{A} {v}_{B} G$$

Neither party needs to know the other's private key and a third party is unable to determine S_{AB} as they would not have knowledge of either private key, v_{A} or v_{B}.

### 2.3 RSA Encryption

For asymmetric encryption RSA may be utilised. For RSA both parties also each have a public-private key pair. The public key is utilised to encrypt the message whereas the private key is used to decrypt the message. There are several key steps in RSA encryption
Generating the RSA modulus (n)
   Select two large primes, p and q. Both are kept secret.
   Calculate n=p×q. The length of n is often referred to in bits. For strong encryption let n be a large number, typically a minimum of 512 bits.
Finding the derived number (e)
   Choose an integer e that is greater than 1 and less than (p−1)(q−1).
   There must be no common factor for e and (p−1)(q−1) except for 1. i.e., the two numbers e and (p−1)(q−1) are coprime.
Composing the public key
   The pair of numbers (n, e) form the RSA public key
Generating the private key
   The private key d is calculated from p, q, and e. For a given n and e, there is a unique number d.
   Number d is the inverse of e modulo (p−1)(q−1). This means that

$$ed = 1 mod ( p - 1 ) ( q - 1 )$$

The Extended Euclidean Algorithm calculates d from the values p, q, and e.

To encrypt a message m with public key (n, e) to produce the cyphertext c, the following equation is utilised

$$c = {m}^{e} ( mod n )$$

To decrypt the cyphertext c with private key d the following computation is utilised

$${c}^{d} = {( {m}^{e} )}^{d} = m ( mod n )$$

### 3. Network Access Control Exchange Protocol

This section describes an example protocol (a “Network Access Protocol”) which may be implemented using specific examples of the embodiments described above. It will be appreciated that some examples are optional.

### 3.1 Communication Between Nodes

This section describes a network access security protocol where the nodes in the network are certified for one of a discrete set of n security levels where n>2 (see FIG. 3). A node certified for security level i, where i∈[1, n], is given health (i.e. security) certificate Cerᵢ.

A certificate Cerᵢ involves the use of digital signature by a certification authority. The signature signs a message that includes identifying information of the node. This identifying information may include the registered public key of the node.

A node with Cerᵢ is considered more secure than a node with certificate Cerⱼ where j>i Communication with another node for a node with certificate Cerᵢ is governed by the following rules:
A node nᵢ with certificate Cerᵢ can send communications to a node with Cerᵢ₊ᵥ, where v≥1.
A node nᵢ with certificate Cerᵢ can send communications to a node with Cerᵢ₋₁.
A node nᵢ with certificate Cerᵢ can receive communications from a node with Cerᵢ₊₁.
A node nᵢ with certificate Cerᵢ can receive communications from a node with Cerᵢ₋ᵥ, where v≥1.

The word ‘communication’ may exclude the sending of identification and certification. All nodes can receive messages that include another node's ID and health certificate.

FIG. 4 shows the lines of communication between nodes from each of the security zones. The node n₂ can be seen as having the ability to dialog directly with the node one security level greater (n₁) and one security level less (n₃). Node n₂ also can send communications directly with the lower security node n₄ but this cannot be reciprocated. i.e., node n₄ cannot send a message directly to n₂. Another node of interest is node n₁ which can dialog with n₂. Node n₁ can send communications to less secure nodes n₃ and n₄. But neither of these two nodes can send messages to node n₁.

### 3.2 Communication for Certificate Authorities

The protocol makes use of multiple Certificate Authorities (CAs). CAs themselves operate within a restricted security zone. A certificate authority CAᵢ is expected to reside within the security zone i. Therefore, CAᵢ is restricted with respect to whom it may communicate. Communication between CAs and nodes is governed by the following principles.
An authority CAᵢ: i≠n is allowed to dialog with any node with certification Cerᵢ, Cerᵢ₊₁, or Cerᵢ₋₁.
The CA with the lowest security clearance CAₙ is allowed to dialog with a new node to network (node has no certification).
An authority CAᵢ is allowed to dialog with CAᵢ₋₁ and CAᵢ₊₁.
A node nᵢ₊₁ in the network must interact directly with a Certification Authority (CAᵢ) to upgrade its health certificate. CAᵢ determines (by itself or via a third-party service) if the node satisfies the criteria for receiving certificate Cerᵢ.
An authority CAᵢ can only certify a node for security health level Cerᵢ
A node with certification Cerᵢ can only upgrade its certification to Cerᵢ₋₁.
All granted health certificates are stored and/or represented on a blockchain 150.

A representation of these lines of communication is shown in FIG. 5.

### 3.3 Private Messaging Between Nodes

The protocol enables private messaging. This means that a message being sent to or from a node should not be readable by an unintended party. This is achieved by encrypting messages. In some examples:
each node nᵢ has an EC public-private key pair. e.g., node nᵢ would possess the pair (kᵢ, Pᵢ) where Pᵢ=kᵢG. This public key is publicly registered or is a provable derivative of a registered public key.
each node has an RSA public-private key pair. e.g., node nᵢ would possess the pair (nᵢ, eᵢ). This pubkey is publicly registered or is a provable derivative of a registered pubkey.

To accomplish dialog between a pair of nodes, messages between the pair of nodes are to be encrypted with a symmetric key. This symmetric key may be obtained by both parties through a Diffie-Hellman exchange (described below). We recall that a node nᵢ can engage in dialog with a node with Cerᵢ₊₁ (nᵢ₊₁) and a node with Cerᵢ₋₁ (nᵢ₋₁). As an example, (see FIG. 4) the node n₂ through a Diffie-Hellman exchange with n₁ produces the shared symmetric encryption key S_{1,2}. This key is used (by both nodes) in encrypting messages in communications between the two nodes. Similarly, node n₂ establishes the shared value S_{2,3} with node n₃.

Where there is to only be one way communication between a node and another, messages from node nᵢ to a less secure node nⱼ where j>i+1, the sending node encrypts the messages with the RSA public key Asⱼ=(nⱼ, eⱼ) of the receiving node. As an example, (see FIG. 4) the node n₁ encrypts messages to n₃ with As₃ and encrypts messages to n₄ with As₄. The node n₂ also communicates with n₄ with As₄.

### 3.4 Protocol Processes

This section describes several processes of the Network Access Protocol.
1. Establishment of the Certificate Authorities.
2. Nodes are certified for the security zone that they satisfy
3. Nodes communicate based on the health-level certificate assigned.

### 3.4.1 Establishment of Certificate Authority Hierarchy

Certificate Authority Establishment represents the creation of n+1 Certificate Authorities for the purposes of certifying the health security level of applying nodes.

### Root Certificate Authority

One of these is the root certificate authority CA_{RT}. This CA is the initiator of the protocol and is the central and most trusted entity in the network. Its identity and public key

$${P}_{R t}^{C A}$$

are known. It has the responsibilities of
Certifying CA₁ as a CA. This is where CA_{Rt} provides a certificate

$$( C e {r}_{1}^{C A} )$$

to CA₁ certifying CA₁ as one of the servers to whom authority is delegated for certifying nodes for having a health security level of

$${Cer}_{1} . {Cer}_{1}^{C A}$$

is a certificate that contains identity (of recipient and signer) and other requisite information applicable to declaring the owner of the signed certificate as a certificate authority.
Certifying the security level of CA₁.
Submitting a signed transaction to the blockchain that contains the metadata

$$Ce {r}_{1}^{C A}$$

for CA₁.
Submitting a signed transaction to the blockchain that contains the metadata Cer₁ for CA₁.

The root certificate authority CA_{Rt} does not have the responsibility of determining or assigning health certificates to any non-CA node in the network.

### Certificate Authorities 1-n

A non-root certificate authority (CAᵢ: i∈[1,n]) is a trusted server in the hierarchy of trusted authorities on the network. Each is assigned a security level and is expected to abide by the corresponding ruleset of that security level. This means that CAᵢ is not allowed to engage in dialog with nodes without health level Cerᵢ₊₁, Cerᵢ, or Cerᵢ₋₁. The CA CAᵢ has the responsibilities of
Certifying CAᵢ₊₁ as a CA. This is where CAᵢ provides a certificate

$$( C e {r}_{i + 1}^{C A} )$$

to CA₁, certifying CAᵢ₊₁ as one of the authorised certificate authorities to whom authority is delegated for certifying nodes for having a health security level of Cerᵢ₊₁.
Accepting certification requests from nodes with a health certificate of at least CAᵢ₊₁, determining if this node satisfies the criteria for CAᵢ, and granting the node the certificate CAᵢ where applicable.
Submitting a signed transaction to the blockchain that contains the metadata

$$Ce {r}_{i + 1}^{C A}$$

for CAᵢ₊₁.
Submitting a signed transaction to the blockchain that contains the metadata Cerᵢ₊₁ for CAᵢ₊₁.
Submitting a signed transaction to the blockchain that contains the metadata Cerᵢ for nᵢ₊₁.

These CA servers may or may not have different hardware-software installed; the key differentiator of the security level of a CA is the security level of the nodes that the CA is allowed to communicate with. An authority CAᵢ is allowed to dialog with nodes nᵢ and nᵢ₊₁.

A chain of trust between the

$$Ce {r}_{i}^{C A}$$

certifications of the CAs may be established. The Root certificate authority CA_{Rt} provides a signature in the CA certificate

$$C e {r}_{1}^{C A}$$

to signify the validity of CA₁ as a certificate authority for security level 1.

$$C e {r}_{1}^{C A}$$

references the identity of its ‘parental authority’. More generically, a CA certification

$$C e {r}_{i}^{C A}$$

contains a signature from its parental authority

$$C e {r}_{i - 1}^{C A}$$

and references the ID of this parental authority. Interested parties would be able to trace the path of trust to the root CA or at least to a CAⱼ:j≤i−1 that they trust.

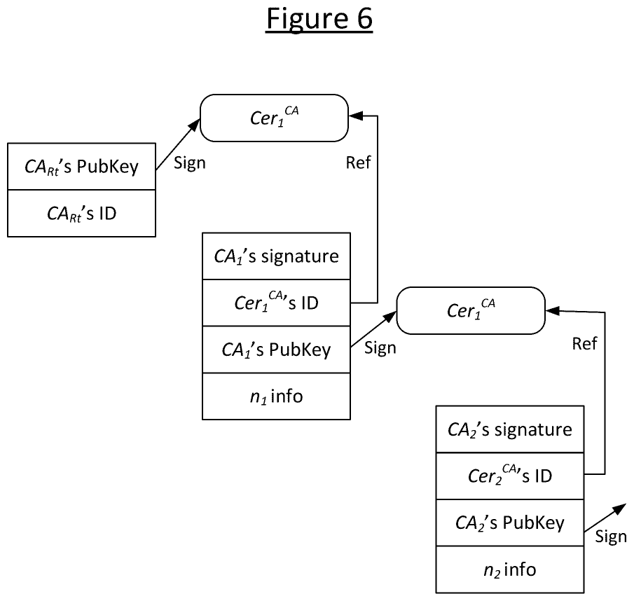

FIG. 6 shows example components of a health certificate Cerᵢ and how the certificates interface with the CA certificates. As an example, we consider the health security certificate Cer₁. Each certificate contains a signature from the issuer. CA₁ provides a digital signature that signs most, if not all, other data in the certificate. The certificate also includes a reference to the issuing certificate authority's certificate

$$( C e {r}_{1}^{C A} ) .$$

This certificate (possibly stored/represented on the blockchain) would have been signed by its parent CA (CA_{Rt}). The certificate Cer₁ also contains a copy of the CA's public key

$$( {P}_{1}^{CA} ) .$$

Said public key (or a provable derivative) is what would be (have been) used to sign the CA certificate of the CA at the next lower security level

$$( C e {r}_{2}^{C A} ) .$$

Finally the certificate Cer₁ will include identifying and other information about the node n₁ that is being granted the certification for the security level 1.

### 3.4.2 Node Certification

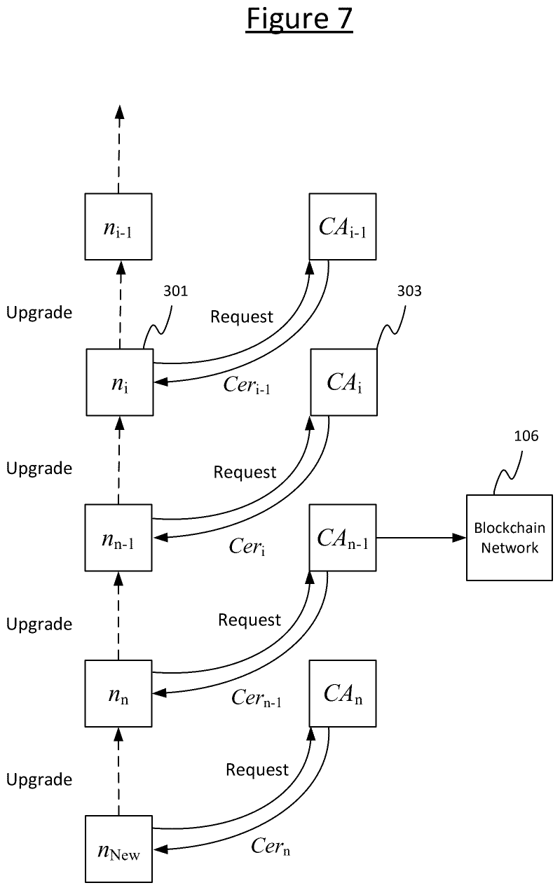

This section describes the processes of a node obtaining a health certificate with reference to FIG. 7.

### New Nodes

A node without any health certificate n_{New} is only allowed to communicate with the CA with the lowest health certificate (CAₙ).
n_{New} would send a request to CAₙ asking to be authorised for certificate Cerₙ.
CAₙ will perform the requisite checks to determine if n_{New} satisfies the criteria.
If so, CAₙ creates a certificate Cerₙ for node n_{New}, sends a copy to n_{New}, and submits a copy to the blockchain.
The previous n_{New} can has been upgraded to nn and can dialog with:
   new nodes,
   nodes with Cerₙ,
   nodes with Cerₙ₋₁
   CAₙ
   CAₙ₋₁

### Node nᵢ

nᵢ sends a request to CAᵢ₋₁ asking to be authorised for certificate Cerᵢ₋₁.
CAᵢ₋₁ will perform the requisite checks to determine if nᵢ satisfies the criteria.
If so, CAᵢ₋₁ creates a certificate Cerᵢ₋₁ for node nᵢ, sends a copy to nᵢ, and submits a copy to the blockchain.
The previous nᵢ has been upgraded to nₙ₋₁ and can dialog with:
   nodes with Cerᵢ,
   nodes with Cerᵢ₋₁,
   nodes with Cerᵢ₋₂
   CAₙ₋₁
   CAₙ₋₂
   CAₙ

### 3.4.3 Node Communication

### New Nodes

A new node n_{New} is allowed to dialog with the least secure nodes nₙ. To communicate with node nₙ the new node the following steps occur:
n_{New} sends a communication request to node nₙ. This communication includes identification information of n_{new} (e.g., its public key P_{new})
nₙ sends a random message m_{Rnd} to n_{new}
n_{new} signs this message with P_{new} and sends signature to nₙ
If signature is valid
   Both parties engage in a Diffie-Hellman exchange producing the shared secret S_{n,New}
   S_{n,New} is used to encrypt messages between both parties in any future dialog
      Node nᵢ to More Secure Node nᵢ₋₁
nᵢ sends a communication request to node nᵢ₋₁. This communication includes identification information of nᵢ (e.g., its public key Pᵢ) as well as its health certificate Cerᵢ (or a reference to transaction with certificate on the blockchain).
nᵢ₋₁ verifies the certificate CAᵢ for node nᵢ
nᵢ₋₁ sends a random message m_{Rnd} to nᵢ
nᵢ signs this message with Pᵢ and sends signature to nₙ₋₁
If signature is valid and certificate verified,
   both parties engage in a Diffie-Hellman exchange producing the shared secret S_{i-1,i}
   S_{i-1,i} is used to encrypt messages between both parties in any future dialog
      Node nᵢ to Less Secure Node nᵢ₊₁
nᵢ sends a communication request to node nᵢ₊₁. This communication includes identification information of nᵢ (e.g., its public key Pᵢ) as well as its health certificate Cerᵢ (or a reference to transaction with certificate on the blockchain).
nᵢ₊₁ verifies the certificate CAᵢ for node nᵢ
nᵢ₊₁ sends a random message m_{Rnd} to nᵢ
nᵢ signs this message with Pᵢ and sends signature to nₙ₊₁
If signature is valid and certificate verified,
   both parties engage in a Diffie-Hellman exchange producing the shared secret S_{i,i+1}
   S_{i,i+1} is used to encrypt messages between both parties in any future dialog
      Node nᵢ to Less Secure Node nⱼ where j>i+1
nᵢ obtains the RSA public key (nⱼ, eⱼ) of node nⱼ. Note that this RSA public key is a registered public key or a provable derivative of a registered public key. [Note also that the nⱼ of the RSA public key (nⱼ, eⱼ) is referencing the RSA modulus (described below) rather than a node nⱼ]
nᵢ encrypts its messages to node nⱼ with the RSA public key.
nᵢ sends the encrypted message to node nⱼ
   Node nᵢ to More Secure Node nₖ where k<i−1

If a node nᵢ wants to communicate with a more secure node nₖ that is at least two secure levels greater, it cannot do this directly. This communication goes through the intermediary nodes and their respective security protocols before arriving at the intended recipient. Node nᵢ sends the message to a node nᵢ₋₁ with the instruction of the final destination. Node nᵢ₋₁ sends the message to a node nᵢ₋₂ with the instruction of the final destination. Etc. This continues until the node arrives at final destination nₖ.

More formally, if a node nᵢ needs to communicate a message m with node nₖ where k<i−1 then the message must be forwarded in sequence through the set of nodes {nₐ:i−1≤a≤k+1}.

If privacy is desired, then node nᵢ may encrypt the message m with the RSA public key (nₖ, eₖ) of node nₖ, and then have it forwarded along the chain.

### 3.5 Revocation and Quarantine

### 3.5.1 Revocation

Health certificates usually include an expiry date, i.e., a date after which the certificate is no longer valid. This gives opportunity for reassessment of the node and its continued ability to satisfy by the criteria for the certificate. In addition, authorities may wish to revoke the certification of nodes (before an expiry date) if the node has failed to abide by the stipulations of that security level.

In the event of the revocation, or expiration of certificate Cerᵢ for a node nᵢ, if the node wishes renewal, that node will have to reapply to CAᵢ for Cerᵢ. If a node knows its certification is nearing expiration, it may apply for renewal while its current certificate is still valid.

It may not be safe to assume that a node with certificate Cerᵢ also has a valid certificate Cerᵢ₊₁ as Cerᵢ₊₁ may have expired. It is assumed that the lifespan of all certificates for the various security zones are the same. In some instances, the lifespan of a security certificate may be uniform across all security zones, or they may only be uniform within a security zone but varying across zones. Lifespans may be customised to the individual nodes. It may be deemed prudent that high security certificates have shorter lifespan, in order to continually reassess and ensure that criteria are being met. This means that a node that loses its Cerᵢ does not automatically default to being in possession of Cerᵢ₊₁ of any Cerⱼ where j>i+1. If a node's certificate Cerᵢ is already expired, then a condition could be incorporated within the protocol, where a node with an expired/revoked certificate Cerᵢ can communicate with and reapply to CAᵢ for a new Cerᵢ using their expired certificate.

Alternatively, a node nᵢ losing its certificate Cerᵢ (and at least Cerᵢ₊₁) may not be allowed to communicate with CAᵢ to request renewal. The (former) node nᵢ would now default to being a node nₓ where x is the highest valid security certificate level the node still possesses a valid certificate for and x>i+1. A worst-case scenario is where the node recedes to being considered as an n_{New}. To re-obtain the certification CAᵢ, node nₓ/n_{New} will have to re-engage in applying for higher levels of security certificates in sequence until it returns to level i.

### 3.5.2 Quarantine

In some instances, nodes may be banned from ever engaging with other nodes in the network. In such cases a blacklist may be maintained with identification of the set of nodes. This list may be stored in a location accessible to all nodes (e.g., blockchain).

Any node that receives a request for communication from another node may first check the blacklist to ascertain whether the requesting node is blacklisted. If the node is blacklisted, then no dialog is allowed with the requesting node.

### 3.6 Representation of Certificates Via Blockchain

The blockchain provides several characteristics and functionalities that make it applicable as a store or representation of digital certificates. The contents being transparent gives access and visibility to any stakeholder interested in certificate data. Meanwhile, the cryptographic functions and smart contract capabilities of blockchain gives opportunities for integrating and improving various aspects of digital certificates.

### 3.6.1 Certificate Storage

An (OP_RETURN) output of a blockchain transaction can be used to store arbitrary data. This data can be the security certificate Cerᵢ or the CA certificate

$$C e {r}_{i}^{C A} .$$

In some instances, a hash of the certificate may be more practical (e.g., data size and privacy reasons) for storage on the blockchain rather than the raw certificate data itself. This hash may be mapped to a hash value in an off-chain hash table that contains the raw certificate data.

An example of certificate storage in a transaction is shown in Table 1 below.

TABLE 1
Storage of Certificate in Bitcoin transaction
TxID_{Cer}

| Version | 1 | Locktime | — |
|---|---|---|---|
| In-count | 1 | Out-count | 2 |
| Input list | | Output list | |
| Outpoint | Unlocking script | Value | Locking script |
| | <Sig_{α}><P_{α}> | x BSV | [Checksig P_{α}] |
| | | 0 | OP_FALSE OP_RETURN <Cerᵢ> |

Note that the entity signing of the input of the transaction is not restricted to being a certificate authority. Anyone can theoretically sign the transaction input; the certificate stored in the (OP_RETURN) output will contain all information, including the digital signatures of the issuer, that give validity to the certificate.

### 3.6.2 Signatures

Rather than having the signature of the issuer be stored in the (OP_RETURN) output, the issuer of the certificate may instead sign an input of the certification transaction TxID_{Cer}. The output may contain other non-signature data that would have bene found in the digital certificate. See Table 2 for an example where CAᵢ signs the input of the certification transaction.

An unspent transaction output may be utilised to represent the continued validity of the certificate. Spending the output may be interpreted to mean that the certification has expired or been revoked. In the example transaction shown in Table 2, the output at index 0 is locked with a script that requires a signature from CAᵢ. If the CA were to spend this output, then the certificate is considered no longer valid.

TABLE 2
Use of transaction to represent certificates
TxID_{Cer}

| Version | 1 | Locktime | — |
|---|---|---|---|
| In-count | 1 | Out-count | 2 |
| Input list | | Output list | |
| Outpoint | Unlocking script | Value | Locking script |
| | $< {Sig}_{i}^{CA} > < {P}_{i}^{C A} >$ | x BSV | $[ Checksig {P}_{i}^{CA} , {P}_{{n}_{i}} ]$ |
| | | 0 | OP_FALSE OP_RETURN |
| | | | <Certificate data> |

### 4. Example Blockchain System Overview

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 5. UTXO-Based Model

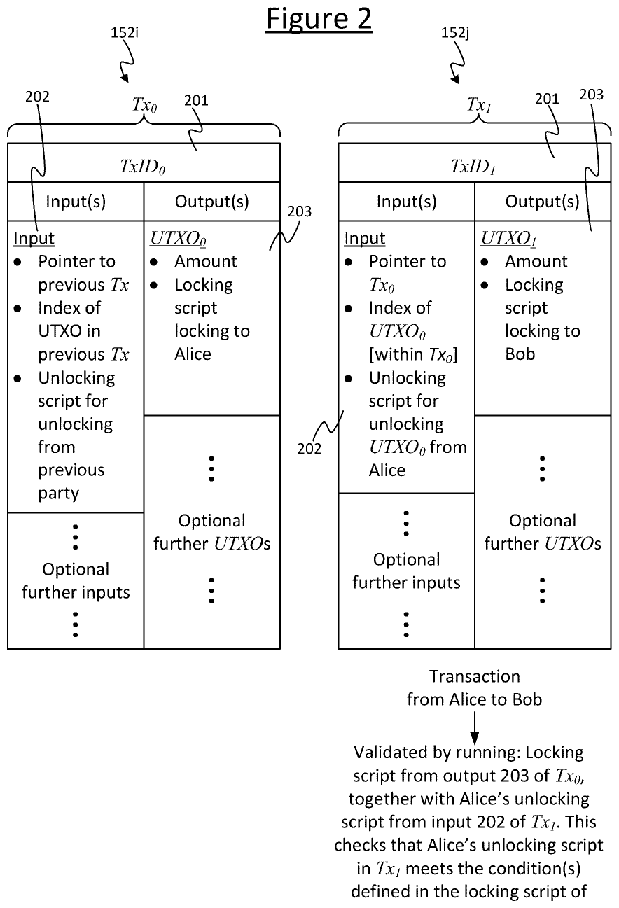

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 6. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 7. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method for secure communication between a set of nodes, wherein a sequence of security levels is defined, wherein a first security level in the sequence is defined as being a most secure level and a final security level in the sequence is defined as being a least secure level, and wherein a respective security of respective security levels in the sequence is defined as decreasing from the first security level to the final security level, wherein each respective node has a respective security certificate associated with a respective security level, wherein each node is configured to communicate with other nodes according to a communication protocol, and wherein the communication protocol defines at least the following rules:
i) a respective node having a respective certificate associated with a respective security level can send messages to a respective node having a respective certificate associated with any less secure security level in the sequence,
ii) a respective node having a respective certificate associated with a respective security level can send messages to a respective node having a respective certificate associated with a next more secure security level adjacent to the respective security level in the sequence, but not to a respective node having a respective certificate associated with a respective security level more secure than the next more secure security level adjacent to the respective security level in the sequence;
iii) a respective node having a respective certificate associated with a respective security level can receive messages from a respective node having a respective certificate associated with a less secure security level adjacent to the respective security level in the sequence, but not to a respective node having a respective certificate associated with a respective security level less secure than the less secure security level adjacent to the respective security level in the sequence; and
iv) a respective node having a respective certificate associated with a respective security level can receive messages from a respective node having a respective certificate associated with any more secure security level in the sequence, and
wherein the method is performed by a first node having a first certificate communicating with a second node having a second certificate according to the communication protocol.

Statement 2. The method of statement 1, wherein the communication protocol defines that messages are sent in encrypted form.

Statement 3. The method of statement 2, wherein the communication protocol defines that messages sent between respective nodes having respective security certificates associated with adjacent security levels in the sequence are encrypted with an encryption key based a public key of the receiving node and a private key of the sending node.

Statement 4. The method of statement 3, wherein the communication protocol defines that in order for messages to be sent between respective nodes having respective security certificates associated with adjacent security levels in the sequence, the following steps are to be performed:
the sending node sends a communication request to the receiving node, wherein the communication request includes the respective security certificate of the sending node or a reference thereto;
the receiving node verifies the respective security certificate of the sending node;
the receiving node sends a verification message to the sending node;
the sending node sends a verification signature to the receiving node, wherein the verification signature based on the verification message and a private key corresponding to the public key of the sending node; and
the receiving node verifies the verification signature.

Statement 5. The method of any statement dependent on statement 2, wherein the communication protocol defines that messages sent between respective nodes having respective security certificates associated with non-adjacent security levels in the sequence are encrypted with an encryption key based on a public key of the receiving node.

Statement 6. The method of statement 5, wherein the communication protocol defines that in order for messages to be sent between respective nodes having respective security certificates associated with non-adjacent security levels in the sequence, wherein the receiving node has a respective security level associated with a more secure level than the sending node, the following steps are to be performed:
the sending node sends a message to a respective node having a security certificate associated with a next more secure security level adjacent to the respective security level in the sequence and requests that the respective node forwards the message to the receiving node.

Statement 7. The method of any preceding statement, wherein each certificate authority of a set of certificate authorities is associated with a respective security level, wherein each security certificate associated with a respective security level is signed by a respective certificate authority associated with the respective security level.

Statement 8. The method of statement 7, wherein each node is configured to communicate with certificate authorities according to the communication protocol, wherein the communication protocol defines at least the following rules:
v) a respective node having a respective security certificate associated with a respective security level can send messages to and receive messages from a respective certificate authority associated with the same respective security level or an adjacent security level in the sequence;
vi) a respective node having a respective security certificate associated with a respective security level can obtain a respective security certificate associate with a next more secure security level in the sequence from a respective certificate authority associated with the next more secure security level.

Statement 9. The method of any preceding statement, wherein some or all of the respective security certificates, or respective hashes thereof, are stored on a blockchain.

Statement 10. The method of any preceding statement, wherein the respective security certificate comprises a respective identifier of the respective node and/or a respective public key of the respective node.

Statement 11. A computer implemented method of issuing security certificates for secure communication between a set of nodes, wherein a sequence of security levels is defined, wherein a first security level in the sequence is defined as being a most secure level and a final security level in the sequence is defined as being a least secure level, and wherein a respective security of respective security levels in the sequence is defined as decreasing from the first security level to the final security level, wherein each respective node has a respective security certificate associated with a respective security level, wherein each certificate authority of a set of certificate authorities is associated with a respective security level, wherein each security certificate associated with a respective security level is signed by a respective certificate authority associated with the respective security level, wherein each certificate authority is configured to issue security certificates according to a certificate issuance protocol, and wherein the certificate issuance protocol defines at least the following rules:
i) a certificate authority associated with a respective security level can issue security certificates associated with the same respective security level;
ii) a certificate authority associated with a respective security level can issue a security certificate to a node having a security certificate with a less secure security level adjacent to the respective security level in the sequence, but not to a node having a security certificate with a less secure security level than the node having the security certificate with the less secure security level adjacent to the respective security level in the sequence; and
iii) a certificate authority associated with a respective security level can re-issue a security certificate to a node having an expired or revoked certificate associated with the same respective security level, and
wherein the method is performed by a first certificate authority and comprises issuing a security certificate to a requesting node according to the certificate issuance protocol.

Statement 12. The method of statement 11, wherein issuing a security certificate to the requesting node comprises:
receiving a request from the requesting node having a respective security certificate associated with a respective security level;
determining that the requesting node can be issued with a respective security certificate associate with a next more secure security level adjacent to the respective security level in the sequence;
generating a respective security certificate associated with the next more secure security level; and
sending the respective security certificate, or a reference thereto, to the requesting node.

Statement 13. The method of statement 12, comprising:
submitting a blockchain transaction to a blockchain network, wherein the blockchain transaction comprises the respective security certificate or a hash thereof, and a signature associated with the first certificate authority.

Statement 14. The method of any statement dependent on statement 11, wherein each certificate authority is configured to communicate with other certificate authorities according to a communication protocol, and wherein the communication protocol defines at least the following rules:
i) a certificate authority associated with a respective security level can communicate with respective certificate authorities having respective security certificates associated with adjacent security levels in the sequence; and
ii) a certificate authority associated with a respective security level can communicate with respective certificate authorities having respective security certificates associated with the same respective security level.

Statement 15. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 14.

Statement 16. A computer program embodied on computer-readable storage and configured so as, when run on one or more processors, to perform the method of any of statements 1 to 14.

According to another aspect disclosed herein, there may be provided a method comprising the actions of the first node and the first certificate authority. According to another aspect disclosed herein, there may be provided a system comprising the computer equipment of the first node and the first certificate authority.

According to another aspect disclosed herein, there may be provided a method comprising the actions of the set of nodes. According to another aspect disclosed herein, there may be provided a system comprising the computer equipment of the set of nodes.

According to another aspect disclosed herein, there may be provided a method comprising the actions of the set of certificate authorities. According to another aspect disclosed herein, there may be provided a system comprising the computer equipment of the set of certificate authorities.

1. A computer-implemented method for secure communication between a set of nodes, wherein a sequence of security levels is defined, wherein a first security level in the sequence is defined as being a most secure level and a final security level in the sequence is defined as being a least secure level, and wherein a respective security of respective security levels in the sequence is defined as decreasing from the first security level to the final security level, wherein each respective node has a respective security certificate associated with a respective security level, wherein each node is configured to communicate with other nodes according to a communication protocol, and wherein the communication protocol defines at least the following rules:
i) a respective node having a respective certificate associated with a respective security level can send messages to a respective node having a respective certificate associated with any less secure security level in the sequence,
ii) a respective node having a respective certificate associated with a respective security level can send messages to a respective node having a respective certificate associated with any one of one or more, but not all, of the next more secure security levels in the sequence;
iii) a respective node having a respective certificate associated with a respective security level can receive messages from a respective node having a respective certificate associated with any one or more, but not all, of the less secure security levels in the sequence; and
iv) a respective node having a respective certificate associated with a respective security level can receive messages from a respective node having a respective certificate associated with any more secure security level in the sequence, and
wherein the method is performed by a first node having a first certificate communicating with a second node having a second certificate according to the communication protocol.

2. (canceled)

3. The method of claim 12, wherein the communication protocol defines that messages are sent in encrypted form, and wherein the communication protocol defines that messages sent between respective nodes having respective security certificates associated with adjacent security levels in the sequence are encrypted with an encryption key based a public key of the receiving node and a private key of the sending node.

4. The method of claim 3, wherein the communication protocol defines that in order for messages to be sent between respective nodes having respective security certificates associated with adjacent security levels in the sequence, the following steps are to be performed:
the sending node sends a communication request to the receiving node, wherein the communication request includes the respective security certificate of the sending node or a reference thereto;
the receiving node verifies the respective security certificate of the sending node;
the receiving node sends a verification message to the sending node;
the sending node sends a verification signature to the receiving node, wherein the verification signature based on the verification message and a private key corresponding to the public key of the sending node; and
the receiving node verifies the verification signature.

5. The method of claim 1, wherein the communication protocol defines that messages are sent in encrypted form, and wherein the communication protocol defines that messages sent between respective nodes having respective security certificates associated with non-adjacent security levels in the sequence are encrypted with an encryption key based on a public key of the receiving node.

6. The method of claim 5, wherein the communication protocol defines that in order for messages to be sent between respective nodes having respective security certificates associated with non-adjacent security levels in the sequence, wherein the receiving node has a respective security level associated with a more secure level than the sending node, the following steps are to be performed:
the sending node sends a message to a respective node having a security certificate associated with a next more secure security level adjacent to the respective security level in the sequence and requests that the respective node forwards the message to the receiving node.

7. The method of claim 1, wherein each certificate authority of a set of certificate authorities is associated with a respective security level, wherein each security certificate associated with a respective security level is signed by a respective certificate authority associated with the respective security level.

8. The method of claim 7, wherein each node is configured to communicate with certificate authorities according to the communication protocol, wherein the communication protocol defines at least the following rules:
v) a respective node having a respective security certificate associated with a respective security level can send messages to and receive messages from a respective certificate authority associated with the same respective security level or an adjacent security level in the sequence;
vi) a respective node having a respective security certificate associated with a respective security level can obtain a respective security certificate associate with a next more secure security level in the sequence from a respective certificate authority associated with the next more secure security level.

9. The method of claim 1, wherein some or all of the respective security certificates, or respective hashes thereof, are stored on a blockchain.

10. The method of claim 1, wherein the respective security certificate comprises a respective identifier of the respective node and/or a respective public key of the respective node.

11. The method of claim 1, wherein for rule ii) of the communication protocol, the one or more, but not all, of the next more secure security levels consists of the next more secure security level adjacent to the respective security level in the sequence.

12. The method of claim 1, wherein for rule ii) of the communication protocol, the one or more, but not all, of the next more security levels comprises one or more security levels within a threshold number of levels from the respective security level in the sequence.

13. The method of claim 12, wherein the threshold is based on one or more of:
a total number of levels in the sequence,
a security setting defined and/or configured by a user of one or more the respective nodes,
a formula based on one or more properties of the set of nodes and/or the sequence of security levels.

14. The method of claim 1, wherein the communication protocol defines at least the following rule:
vii) each respective security level is associated with a respective most secure security level to which nodes having a certificate associated with that respective security level can communicate, and wherein for respective adjacent security levels, the respective most secure security level associated with a less secure adjacent security level is less secure than the respective most secure security level associated with a more secure security level.

15. A computer implemented method of issuing security certificates for secure communication between a set of nodes, wherein a sequence of security levels is defined, wherein a first security level in the sequence is defined as being a most secure level and a final security level in the sequence is defined as being a least secure level, and wherein a respective security of respective security levels in the sequence is defined as decreasing from the first security level to the final security level, wherein each respective node has a respective security certificate associated with a respective security level, wherein each certificate authority of a set of certificate authorities is associated with a respective security level, wherein each security certificate associated with a respective security level is signed by a respective certificate authority associated with the respective security level, wherein each certificate authority is configured to issue security certificates according to a certificate issuance protocol, and wherein the certificate issuance protocol defines at least the following rules:
i) a certificate authority associated with a respective security level can issue security certificates associated with the same respective security level;
ii) a certificate authority associated with a respective security level can issue a security certificate to a node having a security certificate with any one of one or more, but not all, of the less secure security levels in the sequence; and
iii) a certificate authority associated with a respective security level can re-issue a security certificate to a node having an expired or revoked certificate associated with the same respective security level, and
wherein the method is performed by a first certificate authority and comprises issuing a security certificate to a requesting node according to the certificate issuance protocol.

16. The method of claim 15, wherein issuing a security certificate to the requesting node comprises:
receiving a request from the requesting node having a respective security certificate associated with a respective security level;
determining that the requesting node can be issued with a respective security certificate associate with a next more secure security level;
generating a respective security certificate associated with the next more secure security level; and
sending the respective security certificate, or a reference thereto, to the requesting node.

17. The method of claim 16, comprising:
submitting a blockchain transaction to a blockchain network, wherein the blockchain transaction comprises the respective security certificate or a hash thereof, and a signature associated with the first certificate authority.

18. The method of claim 15, wherein each certificate authority is configured to communicate with other certificate authorities according to a communication protocol, and wherein the communication protocol defines at least the following rules:
i) a certificate authority associated with a respective security level can communicate with respective certificate authorities having respective security certificates associated with any one of one or more, but not all, more or less secure security levels in the sequence; and
ii) a certificate authority associated with a respective security level can communicate with respective certificate authorities having respective security certificates associated with the same respective security level.

19. The method of claim 15, wherein for rule ii) of the certificate issuance protocol, the one or more, but not all, of the next less secure security levels consists of the less secure security level adjacent to the respective security level in the sequence.

20. The method of claim 15, wherein for rule ii) of the certificate issuance protocol, the one or more, but not all, of the next less security levels comprises one or more security levels within a threshold number of levels from the respective security level in the sequence.

21-24. (canceled)

25. A non-transitory computer-readable medium, comprising a computer program configured so as, when run on one or more processors, the one or more processors perform a computer-implemented method for secure communication between a set of nodes, wherein a sequence of security levels is defined, wherein a first security level in the sequence is defined as being a most secure level and a final security level in the sequence is defined as being a least secure level, and wherein a respective security of respective security levels in the sequence is defined as decreasing from the first security level to the final security level, wherein each respective node has a respective security certificate associated with a respective security level, wherein each node is configured to communicate with other nodes according to a communication protocol, and wherein the communication protocol defines at least the following rules:
i) a respective node having a respective certificate associated with a respective security level can send messages to a respective node having a respective certificate associated with any less secure security level in the sequence,
ii) a respective node having a respective certificate associated with a respective security level can send messages to a respective node having a respective certificate associated with any one of one or more, but not all, of the next more secure security levels in the sequence;
iii) a respective node having a respective certificate associated with a respective security level can receive messages from a respective node having a respective certificate associated with any one or more, but not all, of the less secure security levels in the sequence; and
iv) a respective node having a respective certificate associated with a respective security level can receive messages from a respective node having a respective certificate associated with any more secure security level in the sequence, and
wherein the method is performed by a first node having a first certificate communicating with a second node having a second certificate according to the communication protocol.
